(19) United States
(12) Patent Application Publication
(10) Pub. No.: US 2006/0037773 A1
(43) Pub. Date: Feb. 23, 2006

(54) Weatherproof electrical enclosure

(76) Inventors: Cosmo Castaldo, Westbury, NY (US); Patricia Roccaro, West Islip, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/182,368

(22) Filed: Jul. 15, 2005

Related U.S. Application Data
(60) Provisional application No. 60/591,896, filed on Jul. 28, 2004.

(51) Int. Cl. H02G 3/14

(52) U.S. Cl. 174/66

(57) ABSTRACT

A weatherproof junction box can also provide security against unauthorized access and tampering of a wiring device in the weatherproof junction box. The weatherproof box for the wiring device includes a recessed port capped with a knock-out plug located at an end of the recessed port. When the knock-out plug is removed, the recessed port may be used to receive an electrical conduit or cable having electrical conductors to enter the weatherproof box.

This application claims the benefit of the filing date of a provisional application having Ser. No. 60/591,896, which was filed on Jul. 28, 2004.

### BACKGROUND OF THE INVENTION

1. Field of the Invention

The present invention relates generally to housings, enclosures, covers for electrical fixtures such as electrical outlets, switches, and plugs. More particularly, the invention is directed toward a new improved weatherproof enclosure for a wiring device

2. Description of Related Art

Outdoor weatherproof boxes for electrical wiring devices such as receptacles, switches etc., are known in the industry. Such boxes typically have a self-closing cover which forms a weather tight fit with the box and weather tight openings for receiving electrical conductors.

The primary purpose of the cover, when closed, is to prevent water, dust etc. from entering the box and the electrical wiring device. Prior art covers of weatherproof boxes provide some protection against water and dust from entering the box when closed. But, when the cover is open, inadequate protection is often provided to the wiring device, particularly when an electrical plug is connected to a receptacle. A need exists for a junction box which provides weather related protection for a wiring device when the cover is closed and when it is opened.

In current weatherproof junction boxes, electrical cables and electrical conduit are attached to the box by the use of threaded connectors which are normally screwed into threaded ports of the junction box. The threaded ports are each furnished with separate screw-in plugs used to cover the ports which are not used. The plugs may be coated with a sealant to insure that they form a weather tight seal with the junction box. A need exists for a junction box which does not use screw-in plugs to seal the unused ports.

In many electrical wiring applications, the electrical junction box may be accessible by a number of unauthorized personnel. Unauthorized access and/or tampering with the electrical wiring devices of the junction box can result in injury to workers servicing downstream electrical equipment. To prevent access to the junction box by unauthorized personnel, a locking mechanism that restricts access to the wiring device in the junction box only to authorized personnel is needed. Also, there may be regulations requiring a locking mechanism that can prevent inadvertent activation of the switch.

### SUMMARY OF THE INVENTION

The present invention obviates the disadvantages and limitations of prior art weatherproof junction boxes while providing security against unauthorized access and tampering of the wiring device in the weatherproof junction box. The weatherproof box for the wiring device includes a recessed port capped with a non-reusable knock-out plug located at an end of the port. The port can be threaded or unthreaded, and the knock-out plug can be removed. The port may be used to receive an electrical conduit or cable having electrical conductors to enter the weatherproof box.

In one aspect, the weatherproof box includes a threaded adapter coupled to the threaded port of the weatherproof box to couple a non-metallic conduit to the weatherproof box. The weatherproof box can include the same or another threaded adapter to couple a flexible wire conductor to the weatherproof box.

An adapter plate is coupled to the weatherproof box to adapt the box to couple a variety of wiring devices into the weatherproof box.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest terms.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1A is an isometric view of a weatherproof box self-closing cover and receptacle in accordance with the principles of the invention;

FIG. 1B is a partial exploded view of the weatherproof box, self-closing cover and receptacle of FIG. 1A;

FIG. 2A is an isometric view of a weatherproof box, self-closing cover and plug in accordance with the principles of the invention;

FIG. 2B is a partial exploded view of the weatherproof box, self-closing cover and plug of FIG. 2A;

FIG. 3A is an isometric view of a weatherproof box and self-closing cover for a toggle switch in accordance with the principles of the invention;

FIG. 3B is a partial exploded view of a weatherproof box and self-closing cover for a toggle switch of FIG. 3A;

FIG. 4A is an isometric view of a weatherproof box and cover for locking a toggle switch in its on or off position in accordance with the principles of the invention;

FIG. 4B is a partial exploded view of the waterproof box and cover of FIG. 4A;

FIG. 5A is an isometric view of a weatherproof box and cover for a GFCI;

FIG. 5B is a partial exploded view of the weatherproof box, cover and GFCI of FIG. 5A;

FIG. 6A is an isometric view of a weatherproof box with a blank wall plate;

FIG. 6B is a partial exploded view of the weatherproof box with the blank wall plate of FIG. 6A;

FIG. 7 is a sectional view along the line 7-7 of FIG. 1B when the weatherproof box is assembled as a unitary member;

FIG. 8 is an isometric view of the weatherproof box without the cover or wiring device;

FIG. 9 illustrates reducers for non-metallic conduit connected to a partial isometric view of the weatherproof box; and

FIG. 10 illustrates a partial isometric view of a weatherproof box and adapters for connecting metallic conduit to the weatherproof box.

### DETAILED DESCRIPTION

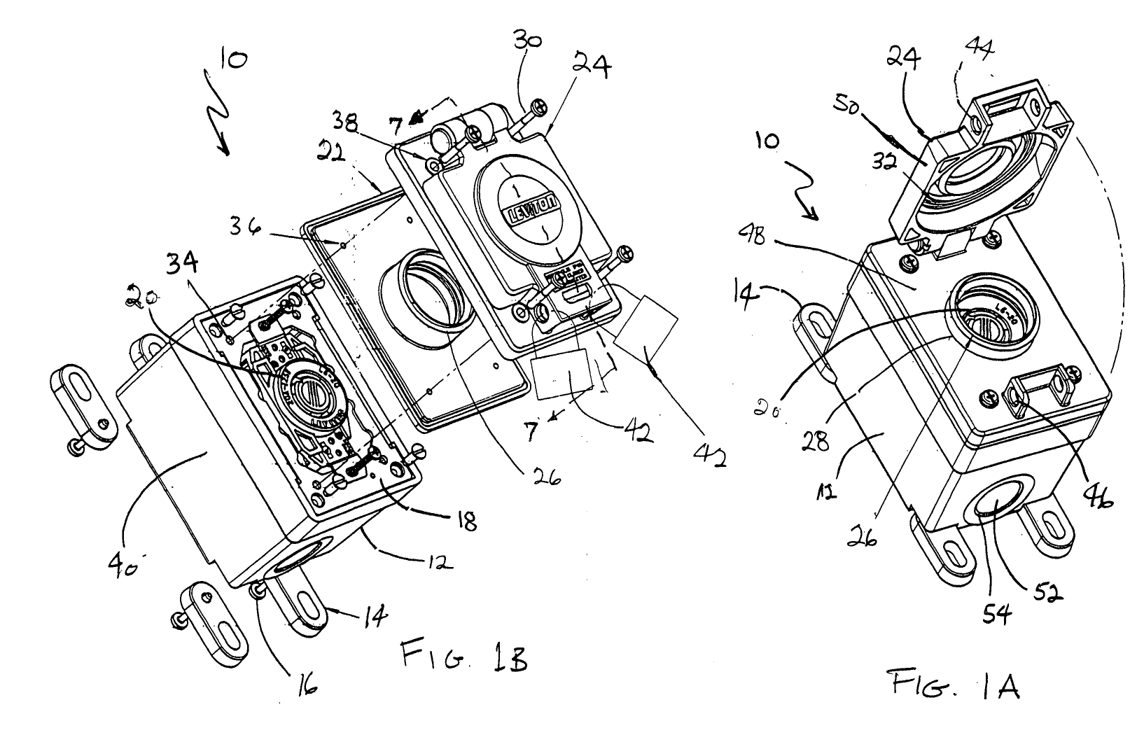

FIG. 1A illustrates an implementation of the weatherproof junction box 10. FIG. 1B illustrates an exploded assembly view of the weatherproof junction box 10 of FIG. 1A. The weatherproof box 10 includes a box 12 having mounting holes (not shown) for mounting the weatherproof box to a mounting surface such as a wall. The weatherproof junction box has mounting lugs 14 that can swivel ninety degrees to provide a wide variety of surface mounting capabilities. The mounting lugs 14 are connected to the box 10 with screws 16 threaded into blind threaded openings (not shown) in the base of the box 10. If desired, the mounting lugs can be removed and the box can be mounted from behind using the blind threaded openings which were used for the mounting lugs. A metal adapter plate 18 can be attached to the box 10. The adapter plate 18 can include holes at appropriate locations to adapt the box 10 to receive a variety of wiring devices.

The box 12 includes a removable knock-out 52. The box 12 may be formed out of plastic and the knock-out 52 formed in the box when the box in molded to form a weatherproof seal. The knock-out 52 can provide a weatherproof seal when attached and, when removed, enable coupling of an electrical cable (not shown) to the box 12. The knock-out is not reusable and once removed may be discarded. A recessed port 54 surrounds the removable knock-out 52 to provide a user with mounting options for electrical connections to the box 12. The recessed port 54 can be threaded or unthreaded.

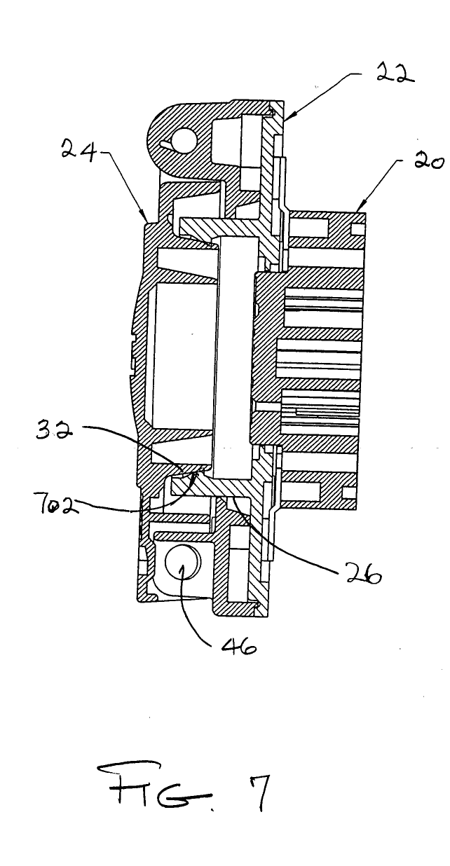

A self-closing cover 24 is a mounted to the box 10. The self-closing cover 24 includes a stationary portion 48 and a hinged portion 50. A rubber gasket 22 is situated between the self-closing cover 24 and the box 10 to provide a weatherproof seal between the cover and box. The rubber gasket 22 can have a ribbed perimeter and a centrally located raised portion 26 that can engage with ribs 32 of the self-closing cover 24 when the cover is in the closed position. A cross-section of the rubber gasket 22 and the self-closing cover is illustrated in FIG. 7. Screws 30 can mount the self-closing cover to holes 34 in the metal plate 18. A rubber grommet 38 can be positioned under the head of screw 30. The screw 30 can pass through holes 36 in the rubber gasket 22 and thread into the metal plate 18 thereby captivating the rubber gasket between the self-closing cover and the metal plate. The holes 36 can be sized to provide a seal against the screw 30 when installed.

The self-closing cover 24 can be configured to receive two separate locks 42, which may be required when electrical maintenance work is being done. The locks 24 can pass through holes 44 in the self-closing cover 50 and holes 46 of the stationary portion 48 of the self-closing cover 24.

In an implementation, the centrally located raised portion 26 is cylindrically shaped and projects upward from a flat portion of the rubber gasket 22. The rubber gasket 22 is positioned between the metal plate 18 which is stationary and the side walls 40 of the junction box. The ribbed perimeter seals the cover plate to the box. The centrally located cylinder provides a seal between the metal plate and the self-closing cover and between the metal cover and a wiring device 20, such as a receptacle, when mounted in the box 10.

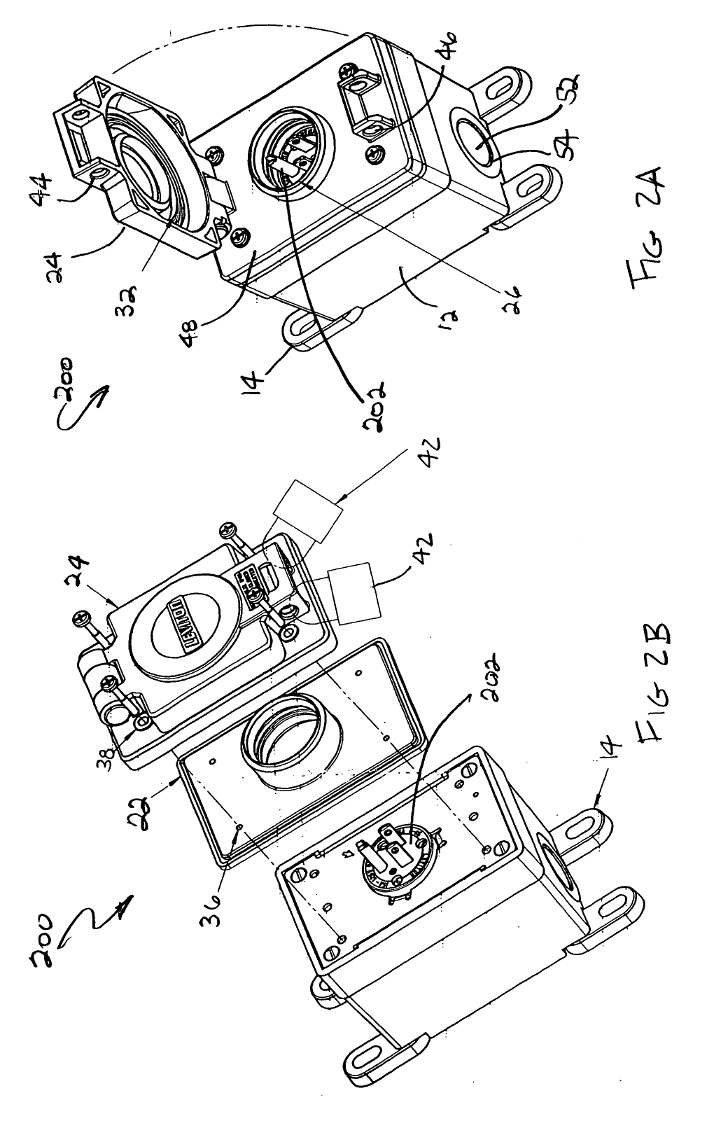

FIG. 2A illustrates an implementation of a weatherproof junction box 200 having a wiring device that is a single plug 202. FIG. 2B illustrates an exploded assembly view of the weatherproof junction box 200 of FIG. 2A. The rubber gasket 22 includes the centrally located cylindrical raised portion 26 that has a circular tapered seal that provides positive sealing when the self-closing cover 24 is closed. When the self-closing cover is open and a receptacle (not shown) is inserted into the plug, the raised portion 26 can help provide resistance to weather encroaching around the receptacle and into the box 12.

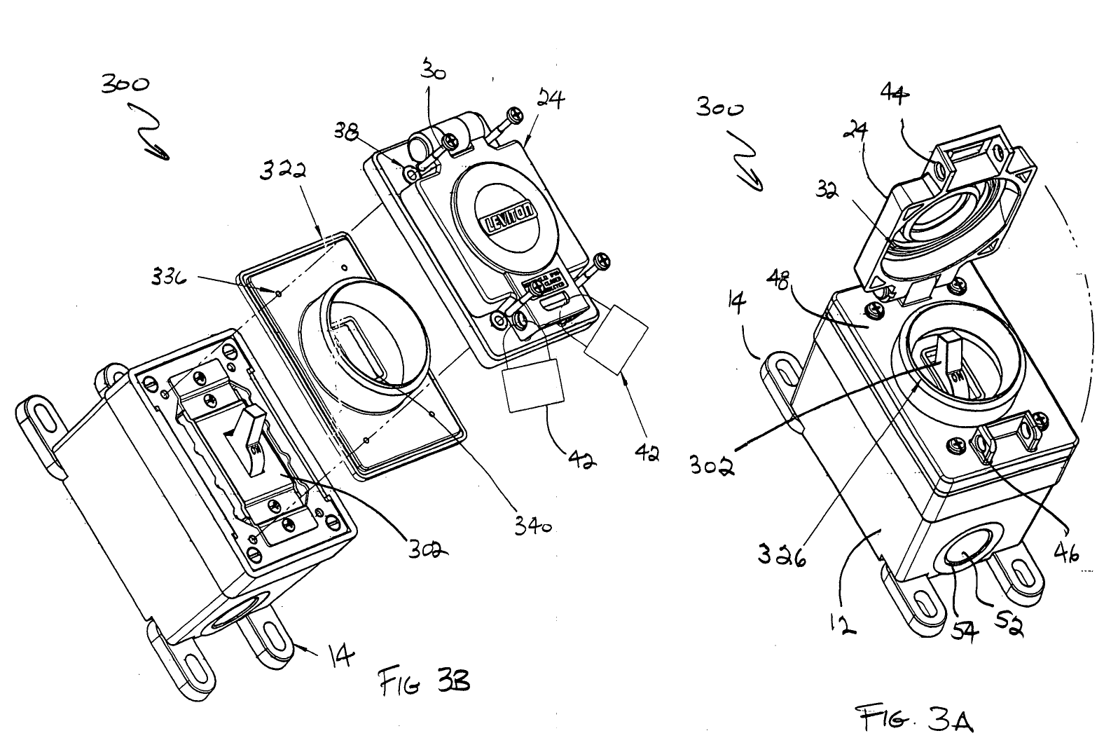

FIG. 3A illustrates an implementation of a weatherproof junction box 300 having a wiring device that is a toggle switch 302. FIG. 3B illustrates an exploded assembly view of the weatherproof junction box 300 of FIG. 3A. A rubber bushing 322 can provide a weatherproof seal between the cover 24 and the box 12. The rubber bushing 322 also can have holes 336 to help seal the toggle switch from weather leakage around mounting screws 30. The rubber bushing 322 has an opening 340 to enable a user to access the toggle switch 302.

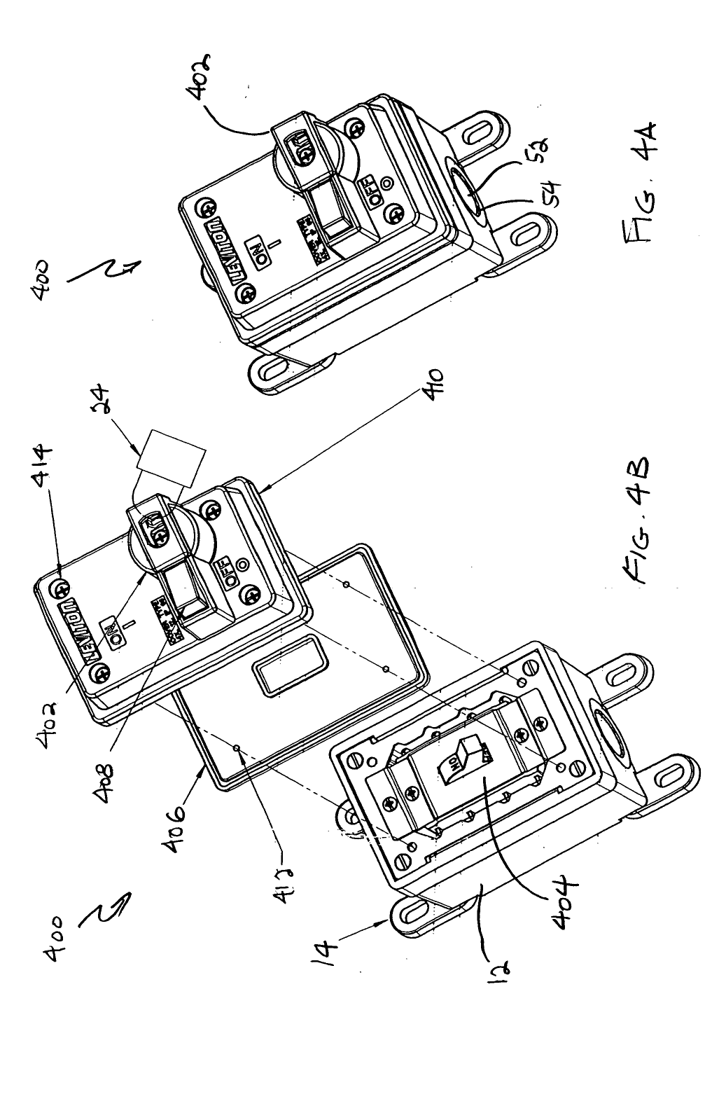

FIG. 4A illustrates an implementation of a weatherproof junction box 400 having a toggle switch 404 and a movable arm 402 for activating the switch that is sealed against the weather with a rubber bushing 406 located inside the movable arm 402. The rubber bushing 406 can provide a weatherproof seal between a cover 410 and the box 12 when the movable arm 402 is in the on or off position. The rubber bushing 406 also can have holes 412 to help seal the toggle switch from weather leakage around mounting screws 414. When the use of a padlock 24 is inconvenient to use, accidental turning of the handle can be avoided by a self locking button 408 on the movable arm 402. The locking button 408 is depressed to enable the movable arm 402 to pivot and actuate the toggle switch 404 so that power can be turned on or off. The locking button 408 is provided to secure the movable arm 402 in either the on or off position to insure that inadvertent switch activation does not occur. The locking button 402 can be of various shapes, and placed at different places on the handle. FIGS. 4a and 4B show one possible position for the locking button 402. An opening in the movable arm 402 allows lockout only when the lever is in the off position.

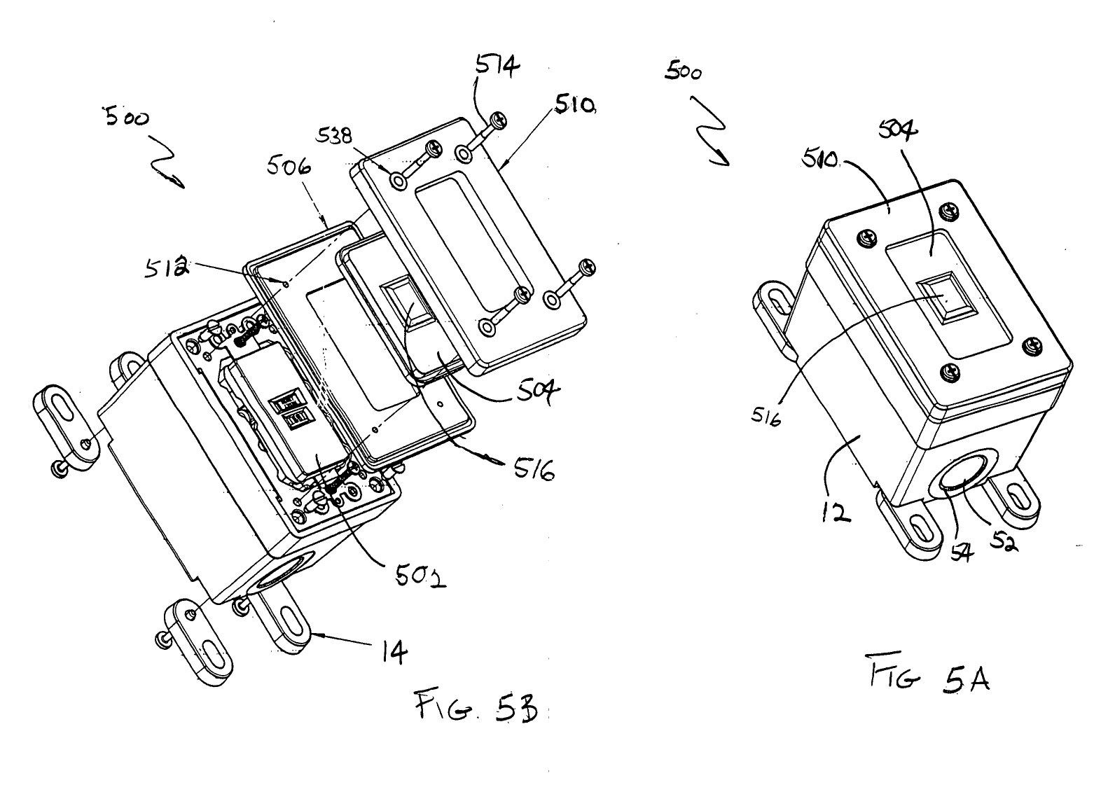

FIG. 5A illustrates an implementation of a weatherproof junction box 500 having an wiring device that is a ground fault circuit interrupter (GFCI) 502. FIG. 5B illustrates an exploded assembly view of the weatherproof junction box 500 of FIG. 5A. When the wiring device is a GFCI 502, a thin membrane 516 flexible enough to allow a user to actuate the test/reset buttons of the GFCI is located across the face of the GFCI and under a cover 510. A rubber bushing 506 can provide a weatherproof seal between the cover 510 and the box 12. The rubber bushing 506 also can have holes 512 to help seal the GFCI from weather leakage around mounting screws 514. Rubber bushing 538 also may be provided under the head mounting screw 514.

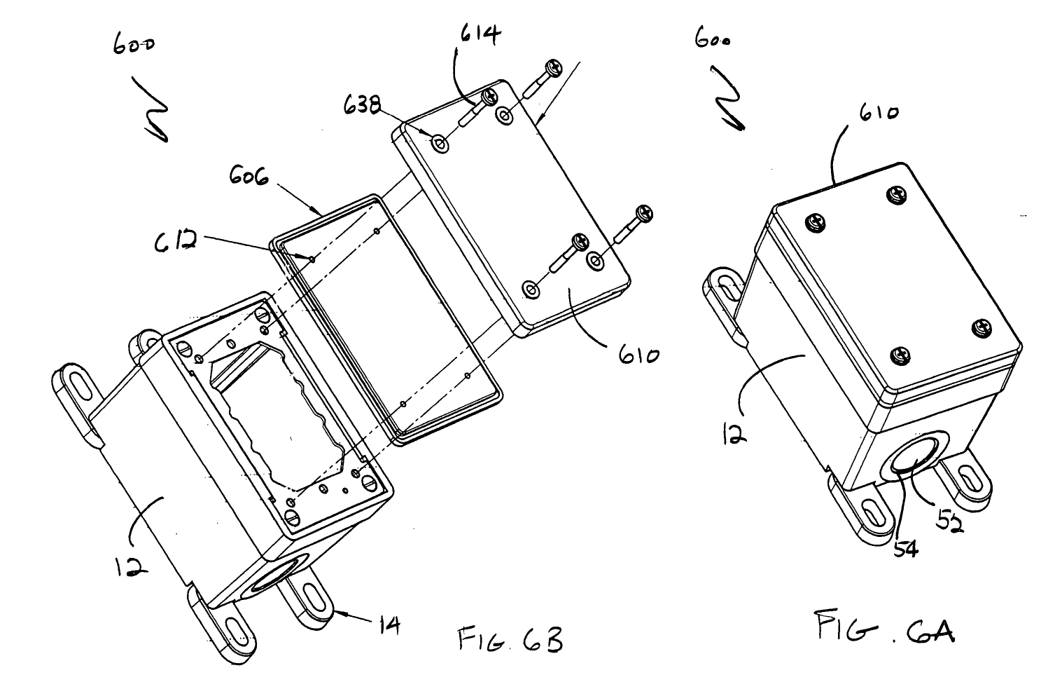

FIG. 6A illustrates an implementation of a weatherproof junction box 600 having a blank cover 610. FIG. 6B illustrates an exploded assembly view of the weatherproof junction box 600 of FIG. 6A. A rubber bushing 606 can provide a weatherproof seal between the cover 610 and the box 12. The rubber bushing 606 also can have holes 612 to help seal the box 12 from weather leakage around mounting screws 614. The rubber bushing 606, in this implementation, does not have a centrally located opening. The cover 610 and bushing 606 can be used to provide a seal for boxes that are used for electrical interconnections or other boxes that do not have a wiring device accessible by a user.

FIG. 7 illustrates a cross-section of the rubber gasket 22, self-closing cover 24 and electrical device 20 of FIG. 1B. Deep tapered ribs 32 on the underside of the self-closing cover 24 mate with a corresponding, but more steeply angled taper 702 on the interior circumference of the upwardly projecting centrally located cylinder 26 to provide positive sealing when the self-closing cover is in the closed position as shown.

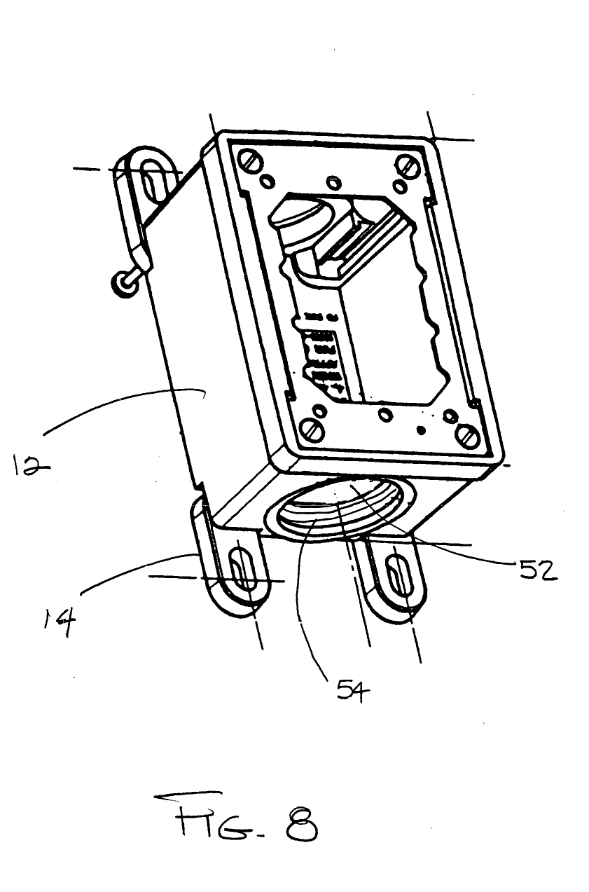

FIG. 8 illustrates a box 12 having a threaded port 54 for coupling the box 12 to a conduit (not shown) for electrical cables or directly to electrical cables. In place of standard pipe threads, the box 12 has the threaded port capped with a weatherproof knock-out plug 52 that seals the interior of the box from the weather. Removal of the knock-out plug enables threaded adapters and reducers that mate with either non-metallic electrical conduit or flexible electrical cable to be inserted through the threaded port and connected to a wiring device in the box.

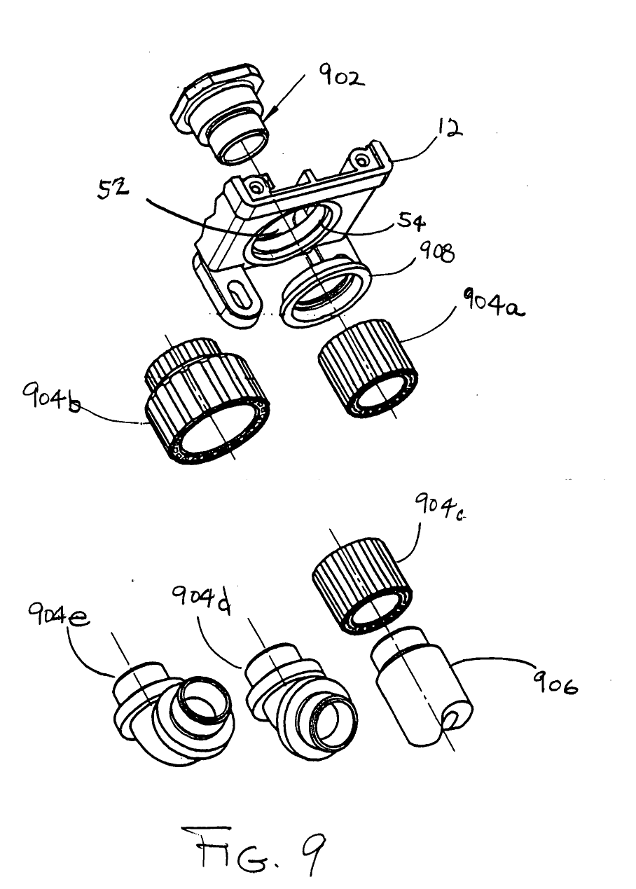

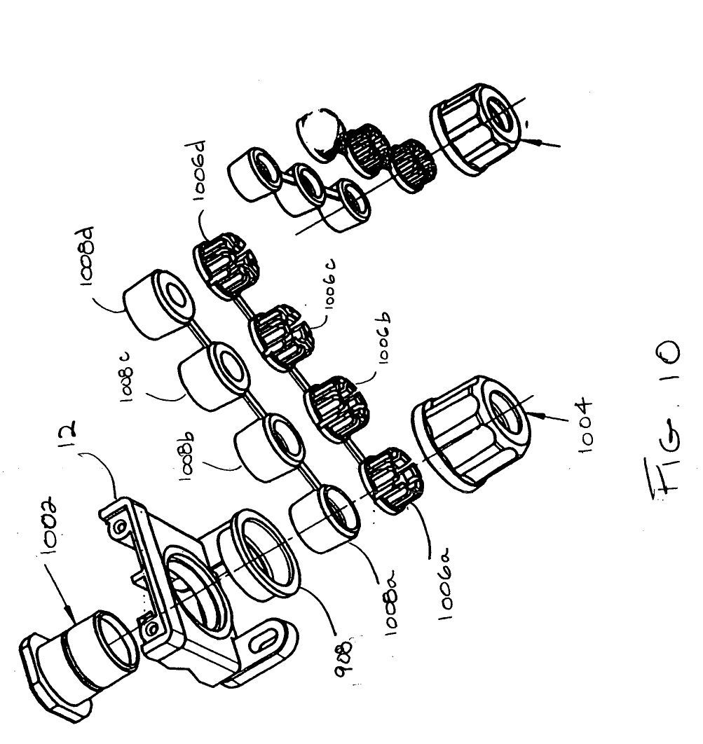

FIGS. 9 and 10 illustrate threaded adapters and reducers that mate with non-metallic and flexible electrical cable, respectively. When the knock-out plug 52 is removed, the threaded port 54 provides a tapered seat for receiving a rubber seal 908 that utilizes the taper in a wedging action to increase the sealing force of the rubber seal to ensure a positive seal under adverse weather related conditions. The rubber seal can provide a weatherproof sealing of the threaded port when the knock-out is removed and opening unused. The interior surface of the rubber seal can have a lip to mate with a corresponding groove in a threaded adapter to complete the seal at the knock-out area of the port.

The threaded port 54 can also provide for sealing using a standard threaded knock-out plug to thread into the threaded port. Referring to FIG. 9, a threaded adapter 902 can be installed through the knock-out 52 and is designed to mate with internally threaded reducers 904a, 904b to facilitate connection to non-metallic electrical conduit (not shown). The reducers 904a, 904b are threaded at each end and are available in several sizes and stepped to accommodate different sizes of conduit. Straight 904c or optional angle adapters 904d, 904e are provided to allow conduits 906 from different directions to be connected to the weatherproof box 12.

Referring to FIG. 10, when flexible electrical cable is connected to the weatherproof box 12, a threaded adapter 1002 is configured to mate with flanged nuts 1004 that also capture serrated strain relief grommets 1006 and tapered rubber seals 1008. The rubber seals and strain relief grommets are of different sizes, 1006a-d and 1008a-d, respectively, to accommodate cables of different diameters. Four different sizes of rubber seals and grommets are illustrated although other sizes may be used.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A weatherproof box for a wiring device comprising:
a recessed port capped with a knock-out plug located at an end of the recessed port.

2. The weatherproof box of claim 1, wherein the recessed port is tapered.

3. The weatherproof box of claim 2, wherein the recessed port is threaded.

4. The weatherproof box of claim 1 further comprising:
a plate adapted to be coupled to a variety of wiring devices and to be coupled to the weatherproof box.

5. The weatherproof box of claim 1 further comprising:
mounting feet pivotably coupled to the bottom of the weatherproof box.

6. The weatherproof box of claim 3 further comprising:
a threaded adapter threaded to the recessed port of the weatherproof box for coupling a non-metallic conduit to the weatherproof box.

7. The weatherproof box of claim 3 further comprising:
a threaded adapter threaded to the recessed port of the weatherproof box for coupling a flexible wire conductor to the weatherproof box.

8. The weatherproof box of claim 1 wherein the weatherproof box has a self-closing cover.

9. The weatherproof box of claim 6 wherein the self-closing cover is adapted to receive different wiring devices.

10. The weatherproof box of claim 1 for receiving a toggle switch comprising;
a handle rotatably coupled to move the toggle of the toggle switch to a first on position or a second off position; and
a self locking button coupled to lock the handle in the first or second position.
